(19) United States
(12) Patent Application Publication
(10) Pub. No.: US 2026/0141017 A1
(43) Pub. Date: May 21, 2026

(54) AI BASED INFORMATION PROCESSING APPARATUS FOR DECISION MAKING SUPPORT, INFORMATION PROCESSING METHOD, AND PROGRAM

(71) Applicant: NEC Corporation, Tokyo (JP)

(72) Inventor: Ryutaro DOI, Tokyo (JP)

(73) Assignee: NEC Corporation, Tokyo (JP)

(21) Appl. No.: 19/361,226

(22) Filed: Oct. 17, 2025

(30) Foreign Application Priority Data
Nov. 15, 2024 (JP) 2024-199825

(51) Int. Cl. G06F 17/11

(52) U.S. Cl. CPC G06F 17/11

(57) ABSTRACT

An information processing apparatus of the present disclosure includes: a priority level setting unit that sets, in accordance with a content of each of constraint conditions set in an optimization problem, a priority level of the constraint condition; a fixed value setting unit that sets, in an order according to the priority level, a variable included in the constraint condition to a fixed value with predetermined value based on the fixed value set for the variable in advance and the content of the constraint condition; and a solving unit that solves the optimization problem with the variable included in the constraint condition set to the fixed value.

### INCORPORATION BY REFERENCE

This application is based upon and claims the benefit of priority from Japanese patent application No. 2024-199825, filed on Nov. 15, 2024, the disclosure of which is incorporated herein in its entirety by reference.

### TECHNICAL FIELD

The present disclosure relates to an AI based information processing apparatus for decision making support, information processing method, and program.

### BACKGROUND ART

As a method for solving real-world problems, it is common practice to transform energy in a combinatorial optimization problem into a formulated Ising model format and then solve it. For example, it is practiced to formulate the energy of an optimization problem in the form of QUBO (Quadratic Unconstrained Binary Optimization) and solve by simulated annealing.

However, as the problem scale of a combinatorial optimization problem increases, the number of solution states becomes enormous, which requires long hours to solve. On the other hand, there is a case where some variables in a problem can be fixed. For example, Patent Literature 1 describes solving by fixing binary variables in various patterns.
Patent Literature 1: Japanese Unexamined Patent Application Publication No. JP-A 2021-131723

### SUMMARY

However, even if some variables are fixed in a constraint-based combinatorial optimization problem as described in Patent Literature 1, there exist numerous fixation patterns, and there remains a problem that a time for solving is still prolonged.

Accordingly, an object of the present disclosure is to solve the aforementioned problem that a time for solving is prolonged in a constraint-constraint combinatorial optimization problem.

An information processing apparatus as an aspect of the present disclosure includes: a priority level setting unit that sets, in accordance with a content of each of constraint conditions set in an optimization problem, a priority level of the constraint condition; a fixed value setting unit that sets, in an order according to the priority level, a variable included in the constraint condition to a fixed value with predetermined value based on the fixed value set for the variable in advance and the content of the constraint condition; and a solving unit that solves the optimization problem with the variable included in the constraint condition set to the fixed value.

Further, an information processing method as an aspect of the present disclosure includes: setting, in accordance with a content of each of constraint conditions set in an optimization problem, a priority level of the constraint condition; setting, in an order according to the priority level, a variable included in the constraint condition to a fixed value with predetermined value based on the fixed value set for the variable in advance and the content of the constraint condition; and solving the optimization problem with the variable included in the constraint condition set to the fixed value.

Further, a program as an aspect of the present disclosure the program comprising instructions for causing an information processing apparatus to execute processes to: set, in accordance with a content of each of constraint conditions set in an optimization problem, a priority level of the constraint condition; set, in an order according to the priority level, a variable included in the constraint condition to a fixed value with predetermined value based on the fixed value set for the variable in advance and the content of the constraint condition; and solve the optimization problem with the variable included in the constraint condition set to the fixed value.

Configured as described above, the present disclosure can inhibit the prolongation of a time for solving in a combinatorial optimization problem.

### BRIEF DESCRIPTION OF THE DRAWINGS

FIG. 1 is a block diagram showing an example of a configuration of an information processing apparatus according to the present disclosure;

FIG. 2 is a flowchart showing an example of processing operation of the information processing apparatus according to the present disclosure;

FIG. 3 is a diagram showing an example of data related to the present disclosure;

FIG. 4 is a diagram showing an example of data related to the present disclosure;

FIG. 5 is a diagram showing an example of a state of processing by the information processing apparatus according to the present disclosure;

FIG. 6 is a diagram showing an example of a state of processing by the information processing apparatus according to the present disclosure;

FIG. 7 is a diagram showing an example of a state of processing by the information processing apparatus according to the present disclosure;

FIG. 8 is a diagram showing an example of a state of processing by the information processing apparatus according to the present disclosure;

FIG. 9 is a diagram showing an example of a state of processing by the information processing apparatus according to the present disclosure;

FIG. 10 is a diagram showing an example of a state of processing by the information processing apparatus according to the present disclosure;

FIG. 11 is a diagram showing an example of a state of processing by the information processing apparatus according to the present disclosure;

FIG. 12 is a diagram showing an example of a state of processing by the information processing apparatus according to the present disclosure;

FIG. 13 is a diagram showing an example of a state of processing by the information processing apparatus according to the present disclosure;

FIG. 14 is a diagram showing an example of a state of processing by the information processing apparatus according to the present disclosure;

FIG. 15 is a diagram showing an example of a state of processing by the information processing apparatus according to the present disclosure;

FIG. 16 is a diagram showing an example of a state of processing by the information processing apparatus according to the present disclosure;

FIG. 17 is a diagram showing an example of a state of processing by the information processing apparatus according to the present disclosure;

FIG. 18 is a diagram showing an example of a state of processing by the information processing apparatus according to the present disclosure;

FIG. 19 is a diagram showing an example of a state of processing by the information processing apparatus according to the present disclosure;

FIG. 20 is a diagram showing an example of a state of processing by the information processing apparatus according to the present disclosure;

FIG. 21 is a block diagram showing an example of a hardware configuration of an information processing apparatus according to the present disclosure; and

FIG. 22 is a block diagram showing an example of a configuration of the information processing apparatus according to the present disclosure.

### EXAMPLE EMBODIMENT

### First Example Embodiment

A first example embodiment of the present disclosure will be described with reference to the drawings. The drawings may be related to any of the example embodiments.

### [Configuration]

An information processing apparatus 10 in the present disclosure is used to solve a preset constraint-based combinatorial optimization problem by simulated quantum annealing (simulated annealing). Here, an example method for solving a constraint-based combinatorial optimization problem by simulated quantum annealing (simulated annealing) will be described. Simulated annealing is an optimization technique in the field of artificial intelligence.

A constraint-based combinatorial optimization problem is a problem in which an objective function and a constraint condition are set and a solution is to be found that minimizes the objective function while satisfying the constraint condition. A constraint-based combinatorial optimization problem can be transformed into, for example, a formulated model such as an Ising model and a QUBO (Quadratic Unconstrained Binary Optimization) model as shown by Formula 1 and Formula 2. An Ising model and a QUBO model are standard models solved by the AI technology. At this point, in a constraint-based combinatorial optimization problem, an energy value E of the optimization problem can be expressed using objective function terms (first and second terms) and constraint condition terms (third and fourth terms) as shown by Formula 1, and they can be integrated into one model as shown by Formula 2.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{ij} {s}_{i} {s}_{j} + {\sum }_{i} {\hat{h}}_{i}^{′} {s}_{i} \qquad [ Formula 1 ]$$

$$E = {\sum }_{i} {\sum }_{j} {J}_{ij} {s}_{i} {s}_{j} + {\sum }_{i} {h}_{i} {s}_{i} = {\sum }_{i} {\sum }_{j} {W}_{ij} {s}_{i} {s}_{j} \qquad [ Formula 2 ]$$

Here, sᵢ and sⱼ in the above formulas are variables representing the states of spins sᵢ and sⱼ, and are expressed as “−1” or “1”, or as “0” or “1”. In this example embodiment, a description will be made assuming that the optimization problem is transformed into the QUBO model and the states of spins i and j are expressed as “0” or “1”. Note that i and j are the identification numbers of the spins s. Further, Wᵢⱼ in the above Formula 2 is a weight parameter set corresponding to each combination of the spins sᵢ and sⱼ.

Then, at the time of solving a spin that minimizes the energy E by simulated quantum annealing in the constraint-based combinatorial optimization problem described above, the state of the spin s flips from 0 to 1 or from 1 to 0, thereby making a solution transition and searching for. At this point, in simulated quantum annealing, at the time of searching for a solution, it transitions at all times when the evaluation value of a neighborhood solution is good (small), but it may transition stochastically even when the evaluation value of a neighborhood solution is bad (large). The probability at this point is determined by an inverse temperature, which is the inverse of the value of a temperature parameter, so that the information processing apparatus 10 searches for a solution while increasing or decreasing the inverse temperature.

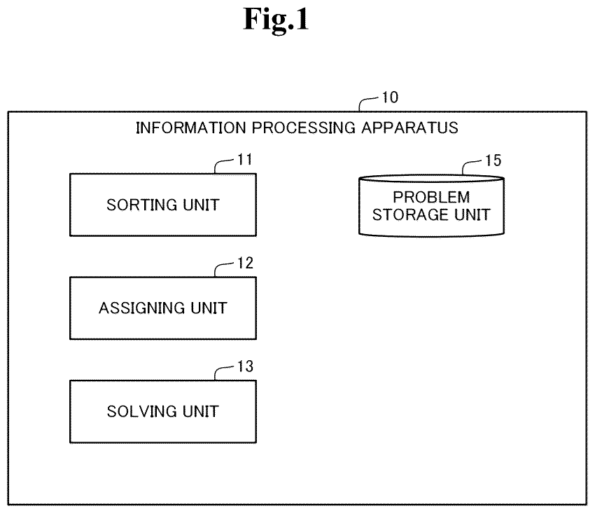

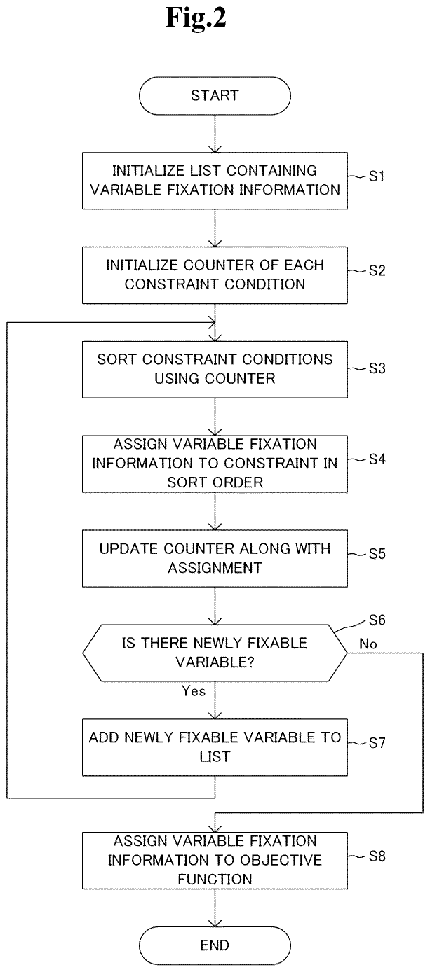

Next, an example of a configuration and operation of the information processing apparatus 10 in this example embodiment will be described in detail. FIG. 1 shows an example of the configuration of the information processing apparatus 10, and FIG. 2 shows an example of the operation of the information processing apparatus 10. The information processing apparatus 10 is configured with one or a plurality of information processing apparatuses each including an arithmetic logic unit and a memory unit. As shown in FIG. 1, the information processing apparatus 10 includes a sorting unit 11, an assigning unit 12, and a solving unit 13. The functions of the sorting unit 11, assigning unit 12, and solving unit 13 can be implemented by execution of a program stored in the memory unit designed to implement the respective functions by the arithmetic logic unit. Moreover, the information processing apparatus 10 includes a problem storage unit 15 implemented by the memory unit.

The problem storage unit 15 stores information representing a constraint-based combinatorial optimization problem to be solved. As an example, one type of constraint-based combinatorial optimization problem is known as a traveling salesman problem. A traveling salesman problem is an optimization problem to find a route with the smallest travel distance, under a constraint condition that a salesman visits all cities once given the distance between the cities. Thus, in the traveling salesman problem, a “One-hot” constraint (sum(xᵢ)=1), which is a constraint that one of the included variables x is 1, is set as a constraint condition. A solution to the traveling salesman problem (an optimal route) can directly support the user's decision making in route selection.

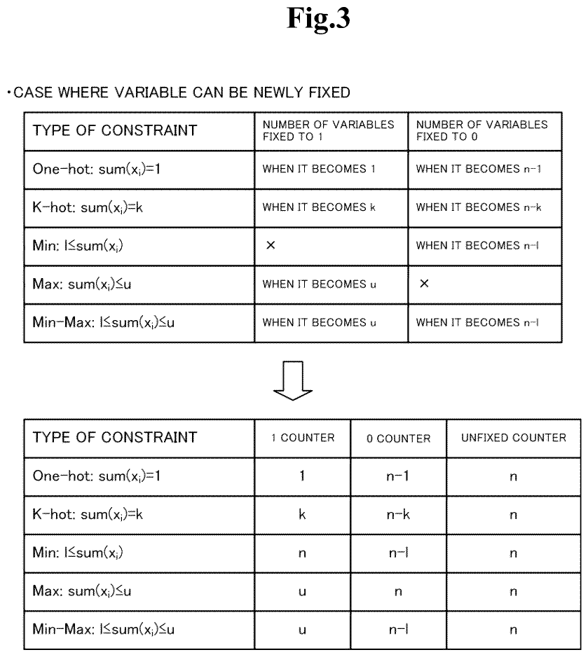

An example of the types of constraints that can be set in an optimization problem is listed in FIG. 3. The constraints include the abovementioned “One-hot” constraint (sum(xᵢ)=1), a “K-hot”constraint where k variables among the included variables x are 1 (sum(xᵢ)=k), a “Min” constraint where one variable x at the minimum is 1 (1≤sum(xᵢ)), a “Max” constraint where u variables x at the maximum are 1 (sum(xᵢ)≤u), a “Min-Max” constraint where one variable x at the minimum and u variables x at the minimum are 1 (1≤sum(xᵢ)≤u), and the like.

Then, in the aforementioned types of constraints, in accordance with the number of variables x set to a fixed value “1” or “0”, it is possible to set the other variable x to a fixed value. For example, in the “One-hot” constraint (sum(xᵢ)=1), when one variable x of n variables x included therein is set to the fixed value “1”, or when (n−1) variables x of the n variables x are set to the fixed value “0”, the other variables x remaining therein can be set to the fixed value “0” or “1”. The upper table in FIG. 3 shows, for each type of constraint, how many variables x are set to the fixed value “1” or “0” to enable the other variables x to be set to the fixed value. Based on such a content of the constraint, In this example embodiment, for each type of constraint, “1 counter” representing the number of variables x of the n variables x included in the constraint that can be set to the fixed value “1”, and “0 counter” representing the number of variables x of the n variables included in the constraint that can be set to the fixed value “0”, and “unfixed counter” representing the number of variables x of the n variables included in the constraint that are not fixed are set, as will be described later.

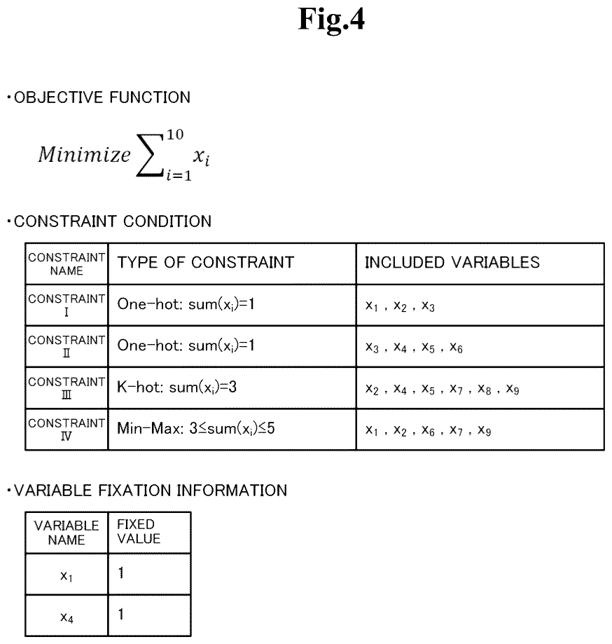

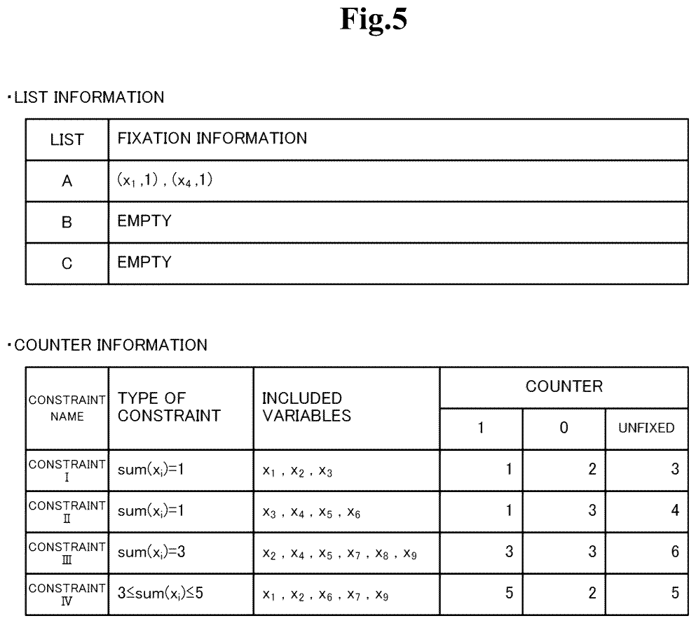

In this example embodiment, a constraint-based combinatorial optimization problem as shown in FIG. 4 (hereinafter also referred to as an optimization problem) is set, which is stored in the problem storage unit 15. Specifically, as an optimization problem, an objective function including ten variables xᵢ shown in the following Formula 3, four constraint conditions each including the variable xᵢ, and variable fixation information representing that variables x₁ and x₄ are fixed values of “1”. Then, the problem storage unit 15 stores, in accordance with the content of the optimization problem, list information of the variable fixation information, and counter information composed of the content of each constraint condition and the number of variables that can be fixed values of predetermined values, as shown in FIG. 5. To be specific, the list has fields “A”, “B”, and “C”, where, as initial values, “(x₁, 1), (x₄, 1)” representing that the variables x₁ and x₄ are fixed values of “1” is set in the field “A” and the fields “B” and “C” are set to be empty. Further, in the counter information, “constraint name”, “content of constraint”, “included variable xᵢ”, and “counter” are set. In accordance with the content of each constraint condition, “1 counter” representing the number of variables that can be fixed values of “1”, “0 counter” representing the number of variables that can be fixed values of “0”, and “unfixed counter” representing the number of unfixed variables are set in “counter”.

$$Minimize {\sum }_{i = 1}^{10} {x}_{i} \qquad [ Formula 3 ]$$

The sorting unit 11 (priority level setting unit) first initializes the list information and the counter information as shown in FIG. 5 (steps S1 and S2 in FIG. 2). Then, in the counter information, the sorting unit 11 sets the priority levels of the constraint conditions according to the contents of the constraint conditions and sorts the constraint conditions in descending order of priority level (step S3 in FIG. 2). At this point, the sorting unit 11 sets the priority levels of the constraint conditions according to the values of the respective counters set in the counter information. Specifically, the sorting unit 11 first sorts by setting a higher priority level for the constraint condition with smaller value of “1 counter” or “0 counter”, which is the number of variables that can be fixed values of “1” or “0”. That is to say, the constraint conditions are sorted in ascending order based on the smaller value of “1 counter” or “0 counter”. Consequently, as will be described later, the constraints are processed in order from the constraint whose variables are most easily fixed. In addition, with respect to the constraint conditions in which the smaller values of “1 counter” or “0 counter” are the same, the sorting unit 11 sorts by setting a higher priority level for the constraint condition with a larger value of “unfixed counter”, which is the number of included variables. In other words, the constraint conditions are sorted in descending order of value of “unfixed counter”. Consequently, as will be described later, it is possible to earlier process the constraint condition in which more variables can be fixed.

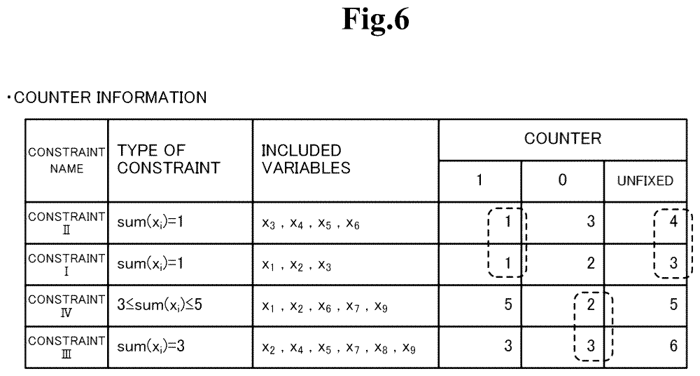

The sorting unit 11 sorts the constraint conditions in order of priority level by the method described above as shown in FIG. 6. Specifically, in the example shown in FIG. 6, as indicated by dotted lines, “Constraint I” and “Constraint II” have smaller “1 counter” values than “Constraint III” and “Constraint IV” and are given higher priority levels. In addition, since the value of “unfixed counter” is greater for “Constraint II” than for “Constraint I”, a higher priority level is set for “Constraint II” over “Constraint I” in order. Then, for the remaining constraints, priority levels are set in order of smaller “0 counter” value, such that “Constraint IV” over “Constraint III”. In this manner, the constraints are sorted in the following order; “Constraint II”, “Constraint I”, “Constraint IV”, and “Constraint III”.

The method of sorting the constraint conditions by the sorting unit 11 is not limited to the aforementioned method, and the constraint conditions may be sorted by other methods. For example, the sorting unit 11 may calculate some metric using the value of each counter and sort the constraint conditions based on the metric.

The assigning unit 12 (fixed value setting unit) performs processing of, in the order of the constraint conditions sorted based on the priority levels as described above, setting the variables included in the constraint conditions to fixed values of predetermined values. Specifically, the assigning unit 12 first assigns a fixed value of predetermined value to a predetermined variable based on the list information (step S4 in FIG. 2). Then, along with assigning the fixed value to the predetermined variable, the assigning unit 12 updates the value of each “counter” in the counter information (step S5 in FIG. 2). At this point, in a case where the value of “1 counter” or “0 counter” becomes “0”, the other variable having not been set to a fixed value in the constraint condition being processed becomes fixable, so that the assigning unit 12 sets the other variable to a fixed value according to the content of the constraint condition. Furthermore, the assigning unit 12 stores the value of the fixed value of the other variable in the field “B” within the list information as the variable fixation information. Then, when the value of “1 counter” or “0 counter” becomes “0” as described above, the assigning unit 12 ends the processing for the current constraint condition, and transitions to processing for the next constraint condition.

Hereinafter, with reference to the drawings, an example of specific processing by the assigning unit 12 will be described. In each figure, data portions of interest are illustrated enclosed by dotted lines.

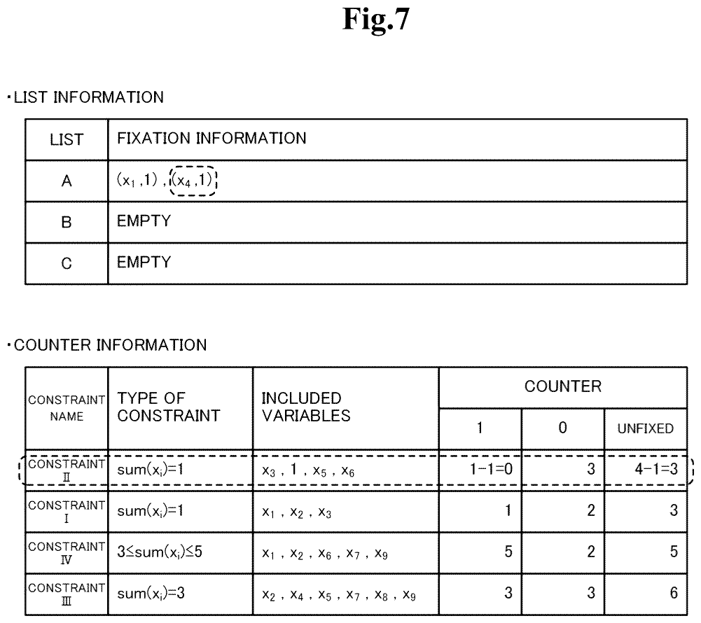

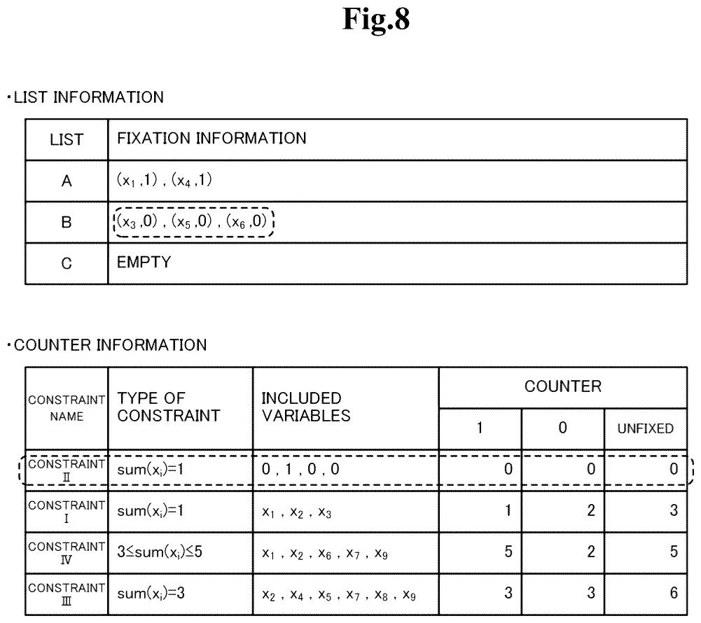

The assigning unit 12 performs the aforementioned processing in order from the highest-priority constraint condition on the constraint conditions sorted in order of priority level as shown in FIG. 6. Therefore, the assigning unit 12 first performs the processing on “Constraint II” as illustrated in FIGS. 7 and 8. As shown in FIG. 7, the assigning unit 12 sets the variable included in “Constraint II” to a fixed value according to the variable fixation information set in the field “A” of the list information. At this point, since the variable x₄ set in the variable fixation information (x₄, 1) is included in “Constraint II”, the assigning unit 12 assigns the fixed value of “1” to the variable x₄ of “Constraint II”. Then, along with assignment of the fixed value of “1” to the variable xX₄ of “Constraint II”, the assigning unit 12 decreases the values of “1 counter” and “unfixed counter” by 1. At this point, “1 counter” becomes “0”, so that the other variables become fixable based on the content of “Constraint II”. Here, based on the content of “Constraint II”, the other variables x₃, x₅, and x₆ can be set to the fixed value “0”, and as shown in FIG. 8, the fixed value of “0” is assigned to the other variables x₃, x₅, and x₆. Then, along with assignment of the fixed value to the other variables, the assigning unit 12 further updates the value of each “counter” and stores the fixed value assigned to the other variables in field “B” of the list information as the variable fixation information. In the example of FIG. 8, “(x₃, 0), (x₅, 0), (x₆, 0)” is stored as the variable fixation information in the field “B” of the list information. Since the value of “1 counter” has become “0”, the assigning unit 12 ends the processing for “Constraint II” and transitions to processing for the next “Constraint I”.

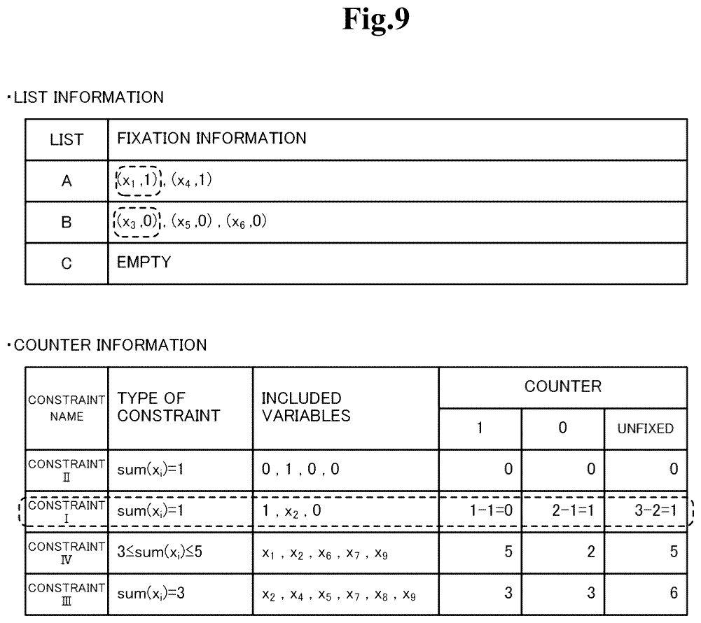

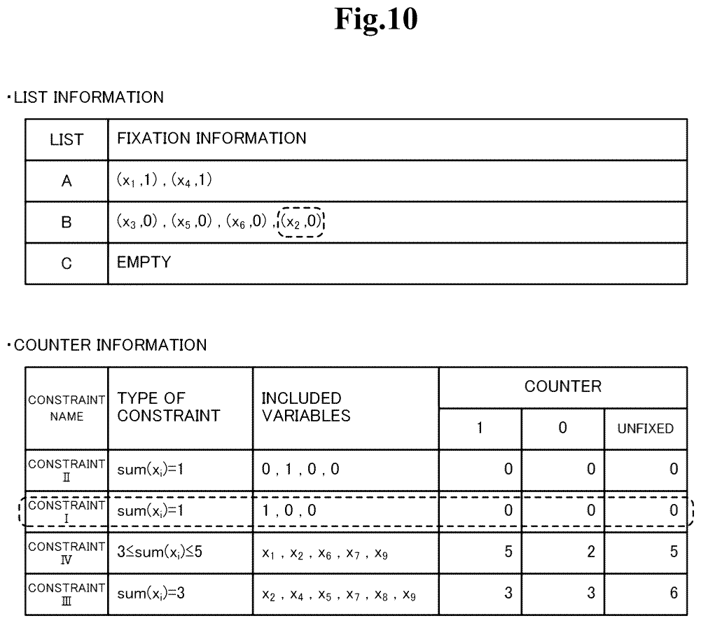

Subsequently, the assigning unit 12 performs processing for “Constraint I” as shown in FIGS. 9 and 10. As shown in FIG. 9, the assigning unit 12 sets the variables included in “Constraint I” to fixed values according to the variable fixation information set in the fields “A” and “B” of the list information. At this point, since the variable x₁ set in the variable fixation information (x₁, 1) of the field “A” is included in “Constraint I”, the assigning unit 12 assigns the fixed value of “1” to the variable x₁ of “Constraint I”. Further, since the variable x₃ set in the variable fixation information (x₃, 0) of the field “B” is included in “Constraint I”, the assigning unit 12 assigns the fixed value of “0” to the variable x₃ of “Constraint I”. Thus, in a case where the constraint condition being currently processed includes the same variable that has already been set to the fixed value in the higher-order constraint condition, the assigning unit 12 sets the variable to the fixed value of the same value.

Then, along with assignment of the fixed value of “1” to the variable x₁ and the fixed value of “0” to the variable x₃ in “Constraint I”, the assigning unit 12 decreases the values of “1 counter” and “0 counter” by 1, and decreases the value of “unfixed counter” by 2. At this point, “1 counter” becomes “0”, and based on the content of “Constraint I”, the other variables become fixable. Here, based on the content of “Constraint I”, the other variable x₂ can be set to the fixed value of “0”, and as shown in FIG. 10, the fixed value of “0” is assigned to the other variable x₂. Then, along with assignment of the fixed value to the other variables, the assigning unit 12 further updates the value of each “counter” and stores the fixed value assigned to the other variables in the field “B” of the list information as the variable fixation information. In the example of FIG. 10, “(x₂, 0)” is added and stored as the variable fixation information into the field “B” of the list information. Since the value of “1 counter” has become “0”, the assigning unit 12 ends the processing for “Constraint I” and transitions to processing for the next “Constraint IV”.

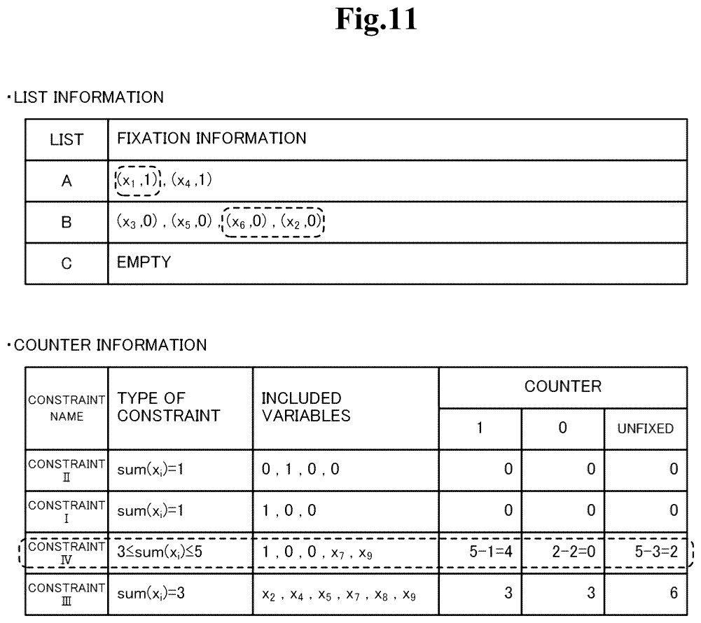

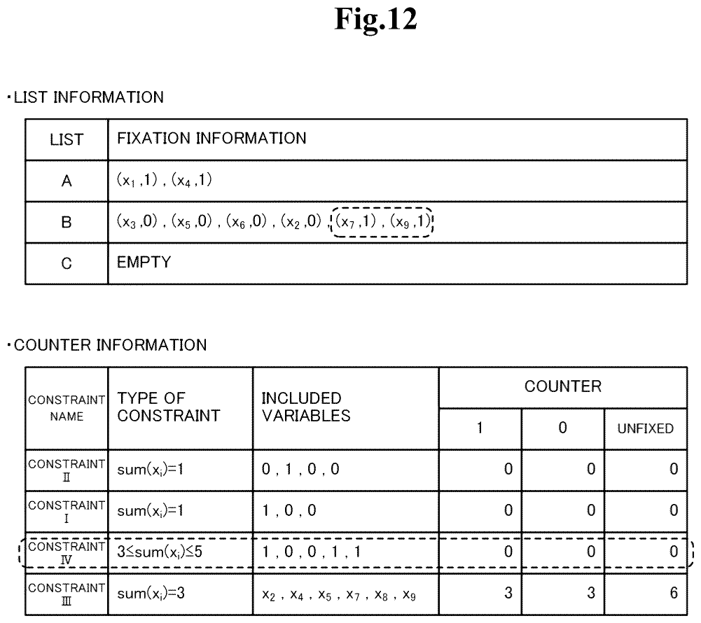

Next, the assigning unit 12 performs processing for “Constraint IV” as shown in FIGS. 11 and 12. As shown in FIG. 11, the assigning unit 12 sets the variables included in “Constraint IV” to fixed values according to the variable fixation information set in the fields “A” and “B” of the list information. At this point, since the variable x₁ set in the variable fixation information (x₁, 1) of the field “A” is included in “Constraint IV”, the fixed value of “1” is assigned to the variable x₁ of “Constraint IV”. Further, since the variables x₂ and x₆ set in the variable fixation information (x₂, 0) and (x₆, 0) of the field “B” are included in “Constraint IV”, the fixed value of “0” is assigned to the variables x₂ and x₆ of “Constraint IV”.

Then, along with assignment of the fixed value of “1” to the variable x₁ and assignment of the fixed value of “0” to the variables x₂ and x₆ of “Constraint IV”, the assigning unit 12 decreases “1 counter” by 1, decreases the value of “0 counter” by 2, and decreases the value of “unfixed counter” by 3. At this point, “0 counter” becomes “0”, and the other variables become fixable based on the content of “Constraint IV”. Here, the other variables x₇ and x₉ can be set to the fixed value of “1” based on the content of “Constraint IV”, and as shown in FIG. 12, the fixed value of “1” is assigned to the other variables x₇ and x₉. Then, along with assignment of the fixed value to the other variables, the assigning unit 12 updates the value of each “counter” and stores the fixed values assigned to the other variables in the field “B” of the list information as the variable fixation information. In the example of FIG. 11, “(x₇, 1), (x₉, 1)” is added and stored as the variable fixation information into the field “B” of the list information. Since the value of “0 counter” has become “0”, the assigning unit 12 ends the processing for “Constraint IV” and transitions to processing for the next “Constraint III”.

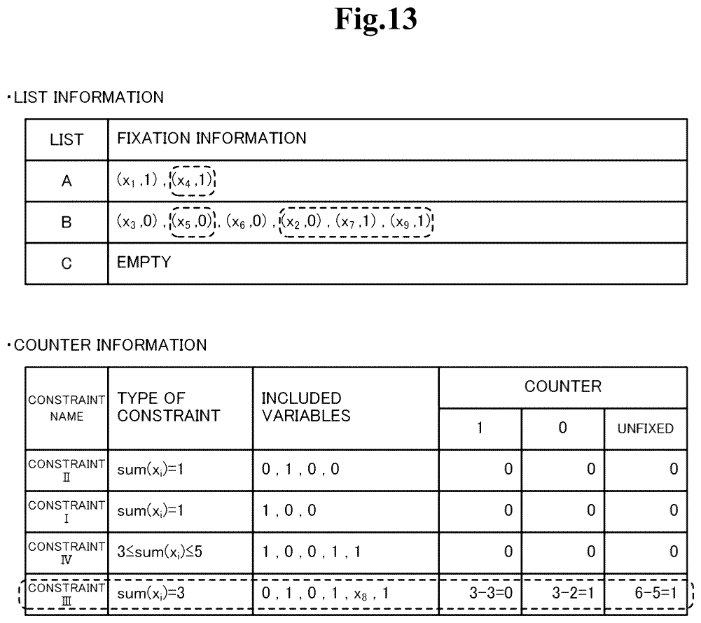

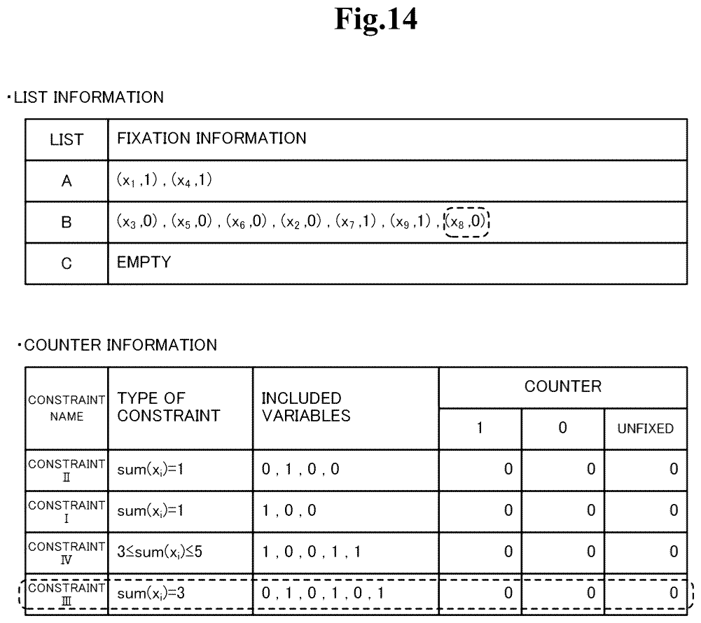

Next, the assigning unit 12 performs processing for “Constraint III” as shown in FIGS. 13 and 14. As shown in FIG. 13, the assigning unit 12 sets the variables included in “Constraint III” to fixed values according to the variable fixation information set in the fields “A” and “B” of the list information. At this point, since the variable x₄ set in the variable fixation information (x₄, 1) in the field “A” is included in “Constraint III”, the fixed value of “1” is assigned to the variable x₄ of “Constraint III”. Further, since the variables x₂, x₅, x₇, and x₉ set in the variable fixation information (x₂, 0), (x₅, 0), (x₇, 1), (x₉, 1) in the field “B” are included in “Constraint III”, the fixed value of “0” is assigned to the variables x₂ and x₅, and the fixed value of “1” is assigned to the variables x₇ and x₉ in “Constraint III”.

Then, along with assigning the fixed value of “1” to the variables x₄, x₇, and x₉ and assigning the fixed value of “0” to the variables x₂ and x₅ in “Constraint III”, the assigning unit 12 decreases “1 counter” by 3, decreases the value of “0 counter” by 2, and decreases the value of “unfixed counter” by 5. At this point, “1 counter” becomes “0”, and based on the content of “Constraint III”, the other variables become fixable. Here, based on the content of “Constraint III”, the other variable x₈ can be set to the fixed value of “0”, and as shown in FIG. 14, the fixed value of “0” is assigned to the other variable x₈. Then, along with assigning the fixed value to the other variables, the assigning unit 12 further updates the value of each “counter” and stores the fixed value assigned to the other variables in the field “B” of the list information as the variable fixation information. In the example of FIG. 14, “(x₈, 0)” is added and stored as the variable fixation information into the field “B” of the list information. The assigning unit 12 ends the processing for “Constraint IV” because the value of “1 counter” has become “0”.

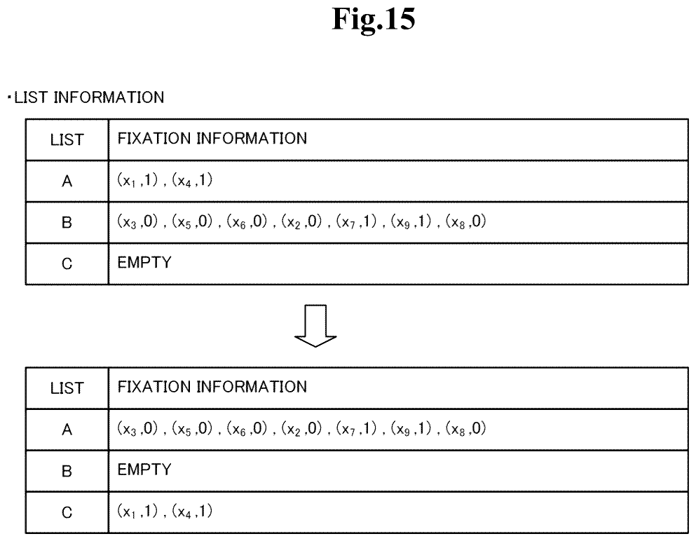

As described above, when the processing for all the constraint conditions is completed in order of priority levels, the assigning unit 12 updates the list information as shown in FIG. 15. Specifically, the assigning unit 12 adds and stores the information from the field “A” into the field “C”, replaces the information in the field “A” with the information in the field “B”, and initializes the field “B” to be empty. Thus, in a case where a newly fixable variable is stored and present in the field “B” (Yes in step S6 of FIG. 2), the assigning unit 12 replaces the information in the field “A” with the information in the field “B” and adds it to the list information as a newly fixable variable (step S7 of FIG. 2).

Subsequently, upon completion of the processing for all the constraint conditions as described above, the aforementioned sorting of constraint conditions and assignment of fixed values to variables are iteratively performed. Specifically, the sorting unit 11 sets the priority level for each constraint condition and sorts the constraint conditions based on the number of variables that can be set to fixed values included in the constraint condition, that is, the value of each “counter” updated (step S3 in FIG. 2). Then, the assigning unit 12 performs the process of assigning fixed values for each constraint condition in order of sorting by priority levels, using the updated list information as described above (steps S4 and S5 in FIG. 2).

In the aforementioned example, since there is no newly fixable variable (No at step S6 in FIG. 2), the process of sorting constraint conditions and assigning fixed values to variables is ended.

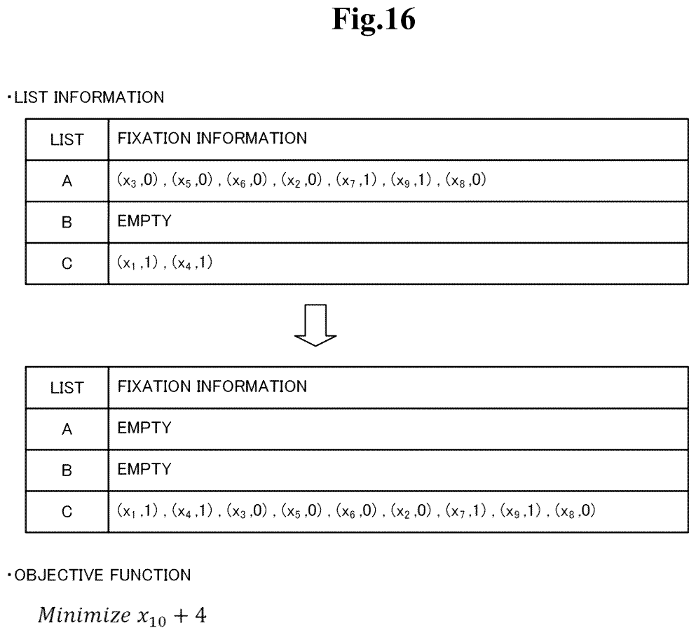

When the process of assigning fixed values is ended as described above, the solving unit 13 updates the objective function of the optimization problem based on the list information (step S8 in FIG. 2). Specifically, as shown in FIG. 16, the solving unit 13 adds the variable fixation information stored in the field “A” of the list information to the field “C”, and sets the information in the field “C” as the final variable fixation information. Subsequently, the solving unit 13 assigns the variable fixation information to the objective function shown in Formula 3, thereby updating the objective function as illustrated in FIG. 16 and Formula 4.

$$Minimize {x}_{10} + 4 \qquad [ Formula 4 ]$$

The solving unit 13 solves the optimization problem with the objective function being updated by assignment of the fixed values as described above. For example, the solving unit 13 solves the optimization problem by simulated quantum annealing. However, the solving unit 13 may solve the optimization problem by any method.

As described above, in this example embodiment, priority levels are set for constraint conditions in a constraint-based combinatorial optimization problem according to the contents of the constraint conditions, and variables are set to fixed values in order of the priority levels. Consequently, the variables can be fixed, the objective function of the optimization problem is simplified, and a reduction in solution time can be achieved.

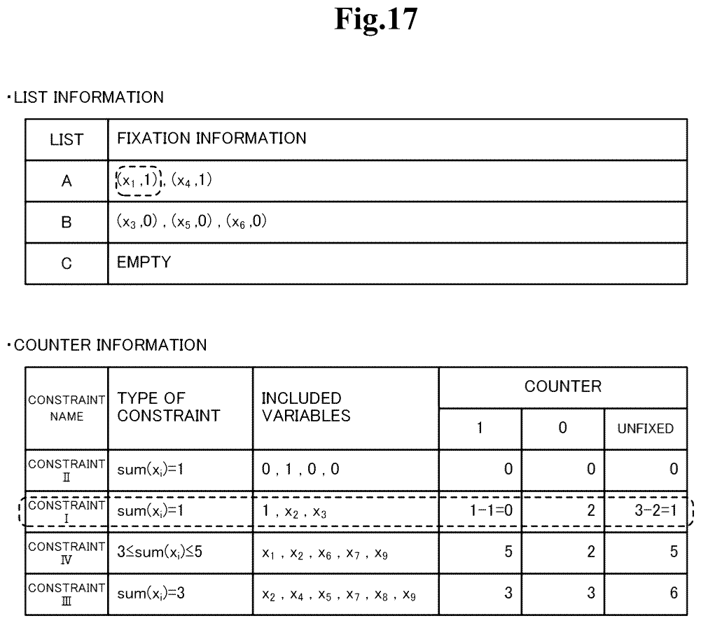

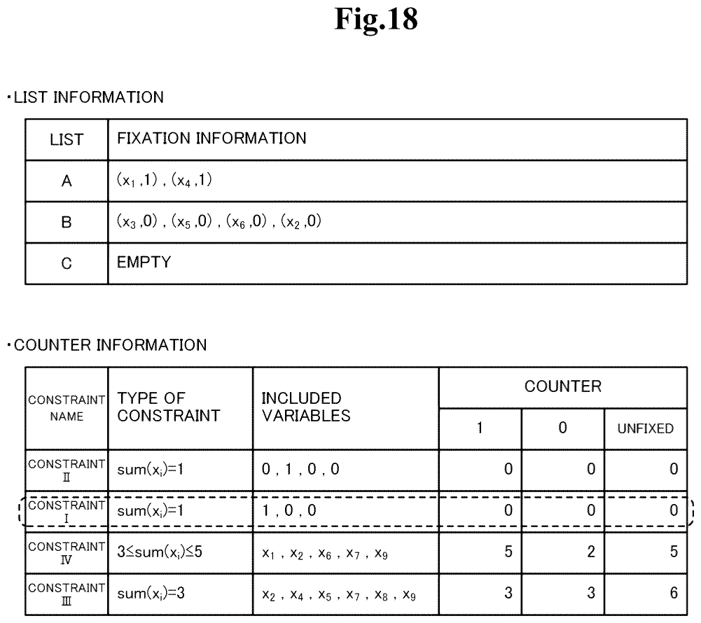

Although, in the above description, the assigning unit 12 assigns the fixed values to the variables in the constraint conditions based on the variable fixation information in the fields “A” and “B” of the list information, it may assign the fixed values to the variables in the following manner. For example, as shown in FIG. 17, in “Constraint I” being processed, a fixed value is first assigned to a variable associated with the smaller of “1 counter” value and “0 counter” value. In this example, the value of “1 counter” is smaller, so that the fixed value of “1” is assigned to the variable x₁ using (x₁, 1) of the variable fixation information. Then, since the value of “1 counter” becomes “0”, as shown in FIG. 18, based on the content of “Constraint I”, it is possible to assign the fixed value of “0” to the remaining variables x₂ and x₃. This enables the reduction of the process of assigning fixed value to variables.

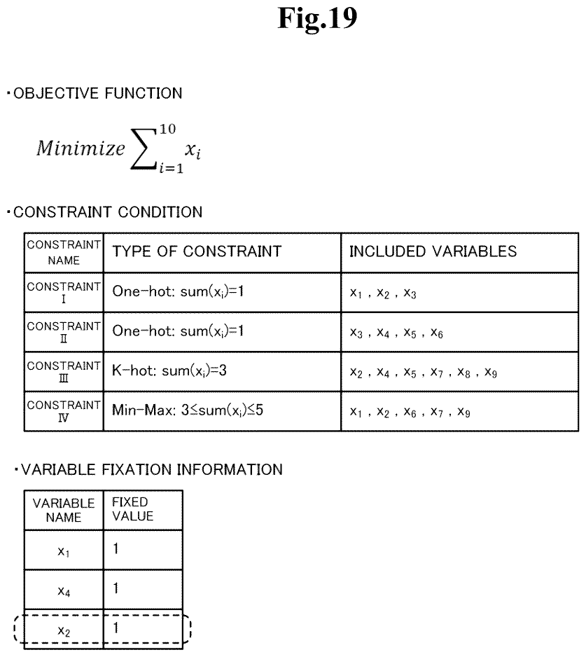

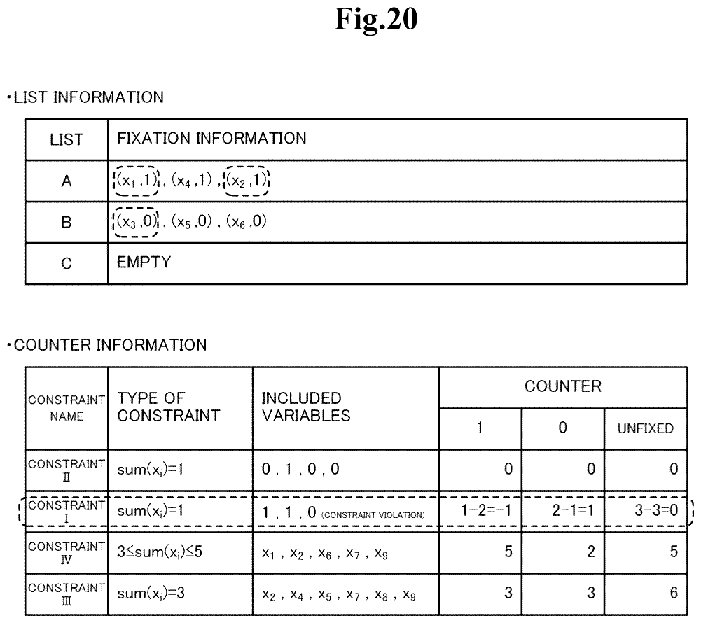

Further, the assigning unit 12 may perform determination of constraint violation of the constraint conditions (inconsistency determination) based on the values of the counters and the number of variables with fixed values being set. Here, the optimization problem is as shown in FIG. 19, and the variable fixation information is “(x₁, 1), (x₄, 1), (x₂, 1)”. In this case, as shown in FIG. 20, in “Constraint I”, while the number of variables that can be set to the fixed value of “1” based on the content of the constraint, that is, “1 counter” is “1”, the number of variables set to the fixed value of “1” is “2”, resulting in the value of “1 counter” being “−1”. In this manner, when the value of “1 counter” or “0 counter” becomes negative, it may be determined that a constraint violation (inconsistency) has occurred, the process may be interrupted, and the fact may be shown to the user. At this point, the information shown to the user can potentially serve as support for the user's subsequent decision making, such as “reviewing the conditions”.

### Second Example Embodiment

Next, a second example embodiment of the present disclosure will be described with reference to the drawings. This example embodiment shows the overview of the information processing apparatus and so forth described in the above example embodiment. The drawings may be related to any of the example embodiments.

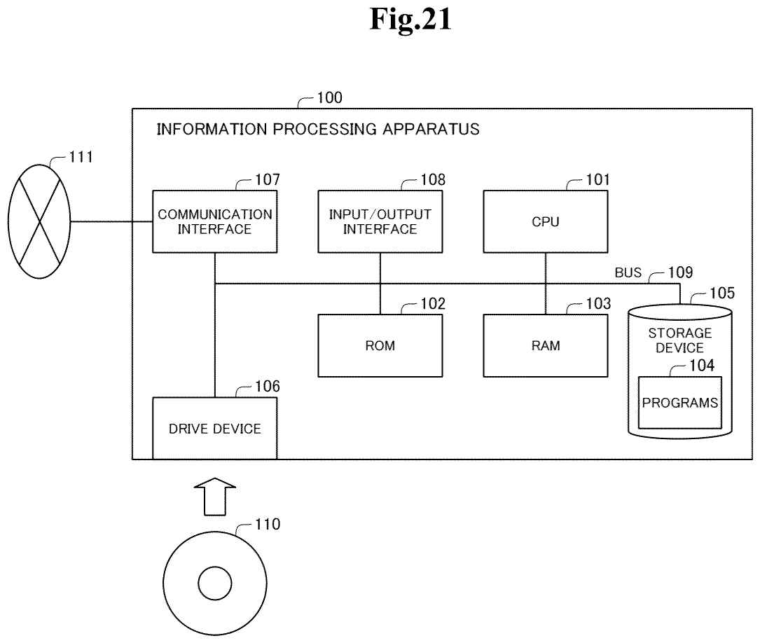

First, a hardware configuration of an information processing apparatus 100 in the present disclosure will be described. The information processing apparatus 100 is configured with a general-purpose information processing apparatus and, as an example, has the following hardware configuration as shown in FIG. 21, including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 21 illustrates an exemplary hardware configuration of the information processing apparatus serving as the information processing apparatus 100, and the hardware configuration of the information processing apparatus is not limited to the aforementioned example. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the abovementioned CPU.

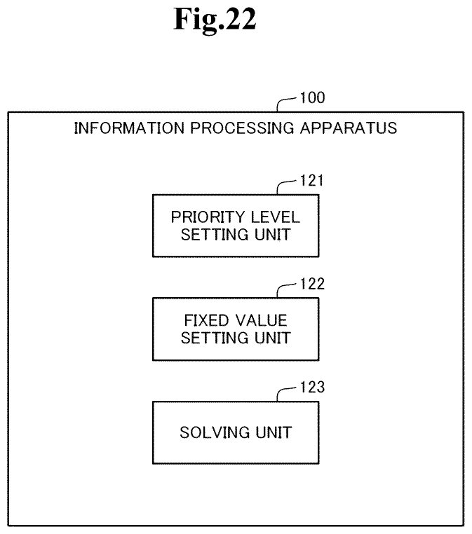

The information processing apparatus 100 can construct and include a priority level setting unit 121, a fixed value setting unit 122, and a solving unit 123 shown in FIG. 22, by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110, and read out by the drive device 106 and provided to the CPU 101. However, the aforementioned priority level setting unit 121, fixed value setting unit 122 and solving unit 123 may be constructed with dedicated electronic circuits designed to implement such means.

The priority level setting unit 121 sets, in accordance with the content of a constraint condition set in an optimization problem, the priority level of the constraint condition. The fixed value setting unit 122 sets a variable included in the constraint condition to a fixed value of a predetermined value, based on a fixed value set for a variable in advance and the content of the constraint condition, in order of the priority level. The solving unit 123 solves the optimization problem with the variable included in the constraint condition being set to the fixed value.

Configured as described above, the present disclosure can achieve shortening of a time for solving a constraint-based combinatorial optimization problem.

At least one or more of the functions of the aforementioned priority level setting unit 121, fixed value setting unit 122 and solving unit 123 may be executed by an information processing apparatus installed and connected at any location on the network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### SUPPLEMENTARY NOTES

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configurations described in the following supplementary notes.

All or some of the configurations described in Supplementary Notes 2 to 8.1 dependent on Supplementary Note 1 below and the functions by such configurations may be dependent on other Supplementary Notes 9 and 10 by the same dependence as Supplementary Notes 2 to 8.1. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### Supplementary Note 1

An information processing apparatus comprising:
at least one memory storing processing instructions; and
at least one processor configured to execute the processing instructions to:
set, in accordance with a content of each of constraint conditions set in an optimization problem, a priority level of the constraint condition;
set, in an order according to the priority level, a variable included in the constraint condition to a fixed value with predetermined value based on the fixed value set for the variable in advance and the content of the constraint condition; and
solve the optimization problem with the variable included in the constraint condition set to the fixed value.

### Supplementary Note 2

The information processing apparatus according to supplementary note 1, wherein the at least one processor is configured to execute the processing instructions to
set a predetermined variable included in the constraint condition to a fixed value with predetermined value set for the predetermined variable in advance, and also set another variable included in the constraint condition to a fixed value with predetermined value in accordance with the content of the constraint condition with the predetermined variable set to the fixed value.

### Supplementary Note 3

The information processing apparatus according to supplementary note 1, wherein the at least one processor is configured to execute the processing instructions to
set a predetermined variable included in the constraint condition to a fixed value with same value as a variable set to a fixed value with predetermined value in the constraint condition of a higher order according to the priority level.

### Supplementary Note 4

The information processing apparatus according to supplementary note 1, wherein the at least one processor is configured to execute the processing instructions to
set the priority level based on a number of variables that can be set to a fixed value with predetermined value according to the content of the constraint condition.

### Supplementary Note 5

The information processing apparatus according to supplementary note 4, wherein the at least one processor is configured to execute the processing instructions to
set the priority level of the constraint condition to be higher as the number of variables that can be set to a fixed value with predetermined value is smaller.

### Supplementary Note 6

The information processing apparatus according to supplementary note 5, wherein the at least one processor is configured to execute the processing instructions to
set the priority level of the constraint condition including a greater number of variables to be higher, among the constraint conditions including a same number of variables that can be set to a fixed value with predetermined value.

### Supplementary Note 7

The information processing apparatus according to supplementary note 1, wherein the at least one processor is configured to execute the processing instructions to
provide each of the constraint conditions with a counter where a number of variables that can be set to a fixed value with predetermined value according to the content of the constraint condition is set and, when performing a process of setting a variable to a fixed value on a predetermined one of the constraint conditions in the order according to the priority level, end the process on the predetermined constraint condition based on a value of the counter in the predetermined constraint condition and a number of variables set to the fixed value with predetermined value.

### Supplementary Note 8

The information processing apparatus according to supplementary note 7, wherein the at least one processor is configured to execute the processing instructions to
determine whether the predetermined constraint condition with the variable set to the fixed value with predetermined value is satisfied, based on the value of the counter in the predetermined constraint condition and the number of variables set to the fixed value with predetermined value.

### Supplementary Note 8.1

The information processing apparatus according to supplementary note 1, wherein the at least one processor is configured to execute the processing instructions to:
after ending the process of setting a variable to a fixed value with predetermined value on all the constraint conditions in the order according to the priority level, newly set the priority level of the constraint condition in accordance with a number of variables having not been set to a fix value included in the constraint condition; and
set the variable included in the constraint condition to a fixed value with predetermined value based on a variable having already been set to a fixed value and the content of the constraint condition in an order according to the newly set priority level.

### Supplementary Note 9

An information processing method comprising:
setting, in accordance with a content of each of constraint conditions set in an optimization problem, a priority level of the constraint condition;
setting, in an order according to the priority level, a variable included in the constraint condition to a fixed value with predetermined value based on the fixed value set for the variable in advance and the content of the constraint condition; and
solving the optimization problem with the variable included in the constraint condition set to the fixed value.

### Supplementary Note 10

A program comprising instructions for causing an information processing apparatus to execute processes to:
set, in accordance with a content of each of constraint conditions set in an optimization problem, a priority level of the constraint condition;
set, in an order according to the priority level, a variable included in the constraint condition to a fixed value with predetermined value based on the fixed value set for the variable in advance and the content of the constraint condition; and
solve the optimization problem with the variable included in the constraint condition set to the fixed value.

### REFERENCE SIGNS LIST

10 information processing apparatus
11 sorting unit
12 assigning unit
13 solving unit
15 problem storage unit
100 information processing apparatus
101 CPU
102 ROM
103 RAM
104 programs
105 storage device
106 drive device
107 communication interface
108 input/output interface
109 bus
110 storage medium
111 communication network
121 priority level setting unit
122 fixed value setting unit
123 solving unit

1. An information processing apparatus comprising:
at least one memory storing processing instructions; and
at least one processor configured to execute the processing instructions to:
set, in accordance with a content of each of constraint conditions set in an optimization problem, a priority level of the constraint condition;
set, in an order according to the priority level, a variable included in the constraint condition to a fixed value with predetermined value based on the fixed value set for the variable in advance and the content of the constraint condition; and
solve the optimization problem with the variable included in the constraint condition set to the fixed value.

2. The information processing apparatus according to claim 1, wherein the at least one processor is configured to execute the processing instructions to
set a predetermined variable included in the constraint condition to a fixed value with predetermined value set for the predetermined variable in advance, and also set another variable included in the constraint condition to a fixed value with predetermined value in accordance with the content of the constraint condition with the predetermined variable set to the fixed value.

3. The information processing apparatus according to claim 1, wherein the at least one processor is configured to execute the processing instructions to
set a predetermined variable included in the constraint condition to a fixed value with same value as a variable set to a fixed value with predetermined value in the constraint condition of a higher order according to the priority level.

4. The information processing apparatus according to claim 1, wherein the at least one processor is configured to execute the processing instructions to
set the priority level based on a number of variables that can be set to a fixed value with predetermined value according to the content of the constraint condition.

5. The information processing apparatus according to claim 4, wherein the at least one processor is configured to execute the processing instructions to
set the priority level of the constraint condition to be higher as the number of variables that can be set to a fixed value with predetermined value is smaller.

6. The information processing apparatus according to claim 5, wherein the at least one processor is configured to execute the processing instructions to
set the priority level of the constraint condition including a greater number of variables to be higher, among the constraint conditions including a same number of variables that can be set to a fixed value with predetermined value.

7. The information processing apparatus according to claim 1, wherein the at least one processor is configured to execute the processing instructions to
provide each of the constraint conditions with a counter where a number of variables that can be set to a fixed value with predetermined value according to the content of the constraint condition is set and, when performing a process of setting a variable to a fixed value on a predetermined one of the constraint conditions in the order according to the priority level, end the process on the predetermined constraint condition based on a value of the counter in the predetermined constraint condition and a number of variables set to the fixed value with predetermined value.

8. The information processing apparatus according to claim 7, wherein the at least one processor is configured to execute the processing instructions to
determine whether the predetermined constraint condition with the variable set to the fixed value with predetermined value is satisfied, based on the value of the counter in the predetermined constraint condition and the number of variables set to the fixed value with predetermined value.

9. The information processing apparatus according to claim 1, wherein the at least one processor is configured to execute the processing instructions to:
after ending the process of setting a variable to a fixed value with predetermined value on all the constraint conditions in the order according to the priority level, newly set the priority level of the constraint condition in accordance with a number of variables having not been set to a fix value included in the constraint condition; and
set the variable included in the constraint condition to a fixed value with predetermined value based on a variable having already been set to a fixed value and the content of the constraint condition in an order according to the newly set priority level.

10. An information processing method comprising:
setting, in accordance with a content of each of constraint conditions set in an optimization problem, a priority level of the constraint condition;
setting, in an order according to the priority level, a variable included in the constraint condition to a fixed value with predetermined value based on the fixed value set for the variable in advance and the content of the constraint condition; and
solving the optimization problem with the variable included in the constraint condition set to the fixed value.

11. The information processing method according to claim 10, comprising
setting a predetermined variable included in the constraint condition to a fixed value with predetermined value set for the predetermined variable in advance, and also setting another variable included in the constraint condition to a fixed value with predetermined value in accordance with the content of the constraint condition with the predetermined variable set to the fixed value.

12. The information processing method according to claim 10, comprising
setting a predetermined variable included in the constraint condition to a fixed value with same value as a variable set to a fixed value with predetermined value in the constraint condition of a higher order according to the priority level.

13. The information processing method according to claim 10, comprising
setting the priority level based on a number of variables that can be set to a fixed value with predetermined value according to the content of the constraint condition.

14. The information processing method according to claim 13, comprising
setting the priority level of the constraint condition to be higher as the number of variables that can be set to a fixed value with predetermined value is smaller.

15. The information processing method according to claim 14, comprising
setting the priority level of the constraint condition including a greater number of variables to be higher, among the constraint conditions including a same number of variables that can be set to a fixed value with predetermined value.

16. The information processing method according to claim 10, comprising
providing each of the constraint conditions with a counter where a number of variables that can be set to a fixed value with predetermined value according to the content of the constraint condition is set and, when performing a process of setting a variable to a fixed value on a predetermined one of the constraint conditions in the order according to the priority level, ending the process on the predetermined constraint condition based on a value of the counter in the predetermined constraint condition and a number of variables set to the fixed value with predetermined value.

17. The information processing method according to claim 16, comprising
determining whether the predetermined constraint condition with the variable set to the fixed value with predetermined value is satisfied, based on the value of the counter in the predetermined constraint condition and the number of variables set to the fixed value with predetermined value.

18. The information processing method according to claim 10, comprising:
after ending the process of setting a variable to a fixed value with predetermined value on all the constraint conditions in the order according to the priority level, newly setting the priority level of the constraint condition in accordance with a number of variables having not been set to a fix value included in the constraint condition; and
setting the variable included in the constraint condition to a fixed value with predetermined value based on a variable having already been set to a fixed value and the content of the constraint condition in an order according to the newly set priority level.

19. A non-transitory computer-readable storage medium storing a program, the program comprising instructions for causing an information processing apparatus to execute processes to:
set, in accordance with a content of each of constraint conditions set in an optimization problem, a priority level of the constraint condition;
set, in an order according to the priority level, a variable included in the constraint condition to a fixed value with predetermined value based on the fixed value set for the variable in advance and the content of the constraint condition; and
solve the optimization problem with the variable included in the constraint condition set to the fixed value.
